(19) United States
(12) Patent Application Publication
(10) Pub. No.: US 2023/0158957 A1
(43) Pub. Date: May 25, 2023

(54) CONTROL DEVICE, CONTROL METHOD, AND STORAGE MEDIUM

(71) Applicant: HONDA MOTOR CO., LTD., Tokyo (JP)

(72) Inventors: Yoshihiro KATSUYAMA, Tokyo (JP); Yuki HARA, Tokyo (JP)

(73) Assignee: HONDA MOTOR CO., LTD., Tokyo (JP)

(21) Appl. No.: 17/991,141

(22) Filed: Nov. 21, 2022

(30) Foreign Application Priority Data
Nov. 24, 2021 (JP) 2021-190066

(51) Int. Cl. B60R 1/28; G06V 20/56

(52) U.S. Cl. CPC B60R 1/28; G06V 20/56; B60R 2300/101; B60R 2300/607

(57) ABSTRACT

A control device includes circuitry configured to: generate a surroundings image of a moving body based on imaging data obtained by an imaging device provided in an openable and closable side mirror of the moving body; cause a display device to display the generated surroundings image; and determine whether the side mirror is in an opened state or a closed state. The circuitry is configured to set, in the surroundings image, a mask area of a range that is based on a determination result as to a state of the side mirror.

### CROSS-REFERENCE TO RELATED APPLICATIONS

This application is based on and claims priority under 35 USC 119 from Japanese Patent Application No. 2021-190066 filed on Nov. 24, 2021, the contents of which are incorporated herein by reference.

### TECHNICAL FIELD

The present disclosure relates to a control device, a control method, and a storage medium storing a control program.

### BACKGROUND ART

In recent years, as a specific measure against global climate change, efforts for implementing a low-carbon society or a decarbonized society have become active. Also in vehicles, reduction in CO₂ emission is strongly required, and automatic driving of vehicles and introduction of driving assistance that contribute to improvement in fuel efficiency are rapidly progressing.

For example, an image generation method has been known in which a predetermined range is imaged by each of cameras mounted on the front, rear, left, and right sides of a vehicle, and a surroundings image (for example, a bird's-eye view image) of the vehicle and the surroundings of the vehicle is generated based on a combined image of the captured images. Japanese Patent No. 5112998 (hereinafter, referred to as Patent Literature 1) discloses a vehicle surroundings monitoring device that changes an imaging range of an image captured by each camera in accordance with opening and closing of a side mirror of a vehicle, and that changes a boundary position between captured images in a combined image of the captured images to generate a birds-eye view image.

When the surroundings of a vehicle are imaged by a camera mounted on a vehicle, a part of the vehicle may be reflected in the captured image. Therefore, in order to prevent the reflection of the vehicle, for example, a mask area is set in the vicinity of the vehicle in a bird's-eye view image. However, when a side mirror of the vehicle is opened and closed, an imaging range of the camera changes, and thus a reflection range of the vehicle also changes with the opening and closing of the side mirror.

Patent Literature 1 fails to disclose generation of a bird's-eye view image corresponding to a change in reflection range of the own vehicle caused by opening and closing of a side mirror. Therefore, in this regard, there is room for improvement in the related art.

An object of the present disclosure is to provide a control device, a control method, and a storage medium storing a control program capable of displaying a good surroundings image regardless of whether a side mirror is opened or closed.

### SUMMARY

A first aspect of the present disclosure a control device including circuitry configured to:

generate a surroundings image of a moving body based on imaging data obtained by an imaging device provided in an openable and closable side mirror of the moving body;

cause a display device to display the generated surroundings image; and

determine whether the side mirror is in an opened state or a closed state,

in which the circuitry is configured to set, in the surroundings image, a mask area of a range that is based on a determination result as to a state of the side mirror.

A second aspect of the present disclosure a control method to be executed by a control device including a processor, in which

the processor is configured to generate a surroundings image of a moving body based on imaging data obtained by an imaging device provided in a side mirror of the moving body and cause a display device to display the generated surroundings image, and

the control method includes:

the processor determining whether the side mirror is in an opened state or a closed state; and

the processor setting, in the surroundings image, a mask area of a range that is based on a determination result as to a state of the side mirror.

A third aspect of the present disclosure a non-transitory computer-readable storage medium storing a control program for causing a processor of a control device to execute processing, in which

the processor generates a surroundings image of a moving body based on imaging data obtained by an imaging device provided in a side mirror of the moving body and causes a, display device to display the generated surroundings image, and

the processing includes:

determining whether the side mirror is in an opened state or a closed state and

setting, in the surroundings image, a mask area of a range that is based on a determination result as to a state of the side mirror.

According to the control device, the control method, and the storing the control program of the present disclosure, it is possible to display a good surroundings image regardless of whether a side mirror is opened or closed.

### BRIEF DESCRIPTION OF DRAWINGS

FIG. 1 is a side view illustrating an example of a vehicle on which a control device of the present embodiment is mounted.

FIG. 2 is a top view of the vehicle illustrated in FIG. 1 in a state where side mirrors are opened.

FIG. 3 is a top view of the vehicle illustrated in FIG. 1 in a state where the side mirrors are closed.

FIG. 4 is a block diagram illustrating an internal configuration of the vehicle illustrated in FIG. 1.

FIG. 5 is a flowchart illustrating an example of display control performed by a control ECU.

FIG. 6 is a diagram illustrating an example of a mask area set when the side mirrors are in an opened state.

FIG. 7 is a diagram illustrating an example of a mask area set when the side mirrors are in a closed state.

FIG. 8 is a diagram illustrating an example of a bird's-eye view image displayed on a touch screen.

### DESCRIPTION OF EMBODIMENTS

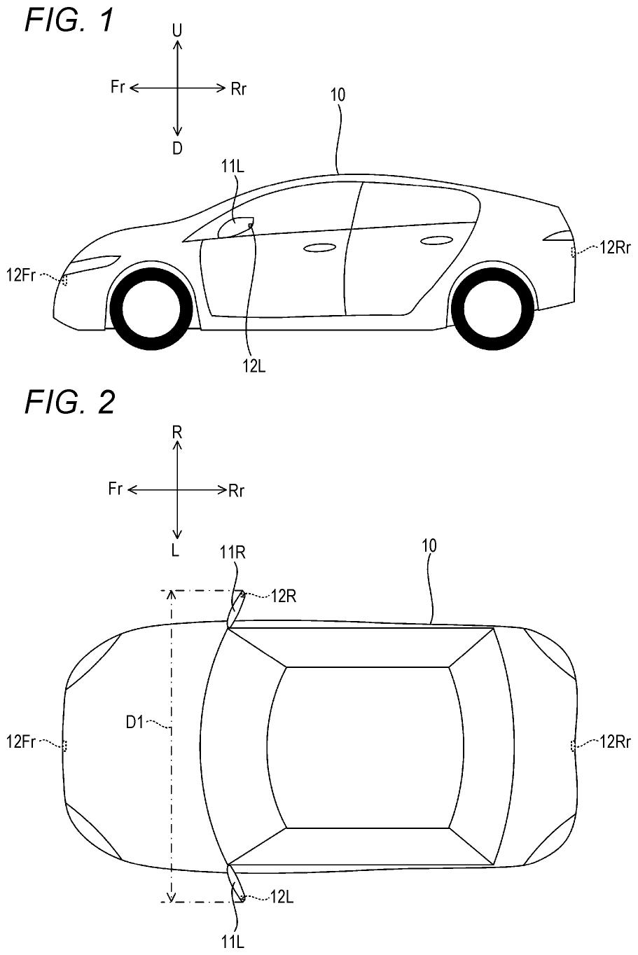

Hereinafter, an embodiment of a control device, a control method, and a storage medium storing a control program according to the present disclosure will be described with reference to the accompanying drawings. Note that the drawings are to be viewed according to orientation of the reference signs. In the present specification and the like, in order to simplify and clarify the description, a front-rear direction, a left-right direction, and an up-down direction are described in accordance with directions viewed from a driver of a vehicle 10 illustrated in FIGS. 1 to 3. In the drawings, a front side of the vehicle 10 is denoted by Fr, a rear side thereof is denoted by Rr, a left side thereof is denoted by L, a right side thereof is denoted by R, an upper side thereof is denoted by U, and a lower side thereof is denoted by D.

<Vehicle 10 on which Control Device of the Present Disclosure is Mounted>

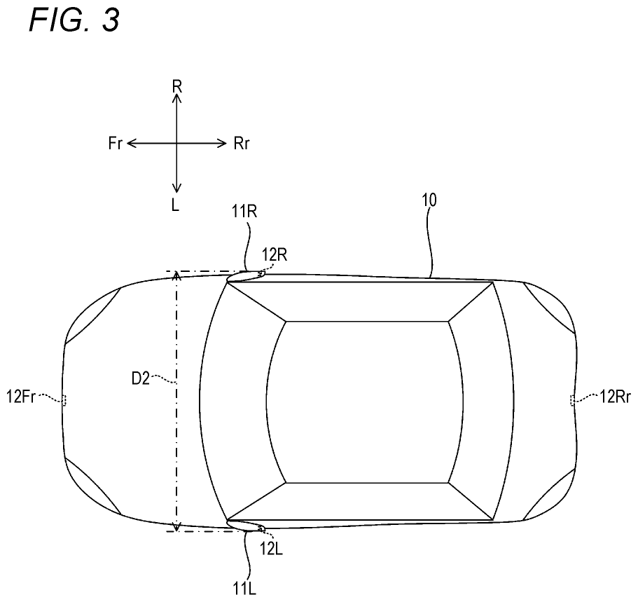

FIG. 1 is a side view of the vehicle 10 on which a control device according to the present disclosure is mounted. FIGS. 2 and 3 are top views of the vehicle 10 illustrated in FIG. 1, The vehicle 10 is an example of a moving body of the present disclosure.

The vehicle 10 is an automobile that includes a driving source (not illustrated) and wheels including drive wheels driven by power of the driving source and steerable steering wheels. In the present embodiment, the vehicle 10 is a four-wheeled automobile having a pair of left and right front wheels and a pair of left and right rear wheels. The driving source of the vehicle 10 is, for example, an electric motor. The driving source of the vehicle 10 may be an internal combustion engine such as a gasoline engine or a diesel engine, or may be a combination of an electric motor and an internal combustion engine. The driving source of the vehicle 10 may drive the pair of left and right front wheels, the pair of left and right rear wheels, or four wheels of the pair of left and right front wheels and the pair of left and right rear wheels. Both the front wheels and the rear wheels may be steerable steering wheels, or the front wheels or the rear wheels may be steerable steering wheels.

The vehicle 10 further includes side mirrors 11L and 11R. The side mirrors 11L and 11R are mirrors (rearview mirrors) that are provided at outer sides of front seat doors of the vehicle 10 and that allow a driver to check the rear side and rear lateral sides.

Each of the side mirrors 11L and 11R is fixed to a body of the vehicle 10 by a rotation shaft extending in the up-down direction, and can be opened and closed by rotating about the rotation shaft. The side mirrors 11L and 11R, are electrically opened and closed by, for example, a driver's operation on an operation part provided in the vicinity of a driver's seat of the vehicle 10.

When the side mirrors 11L and 11R are in use (for example, when the vehicle 10 is traveling), the side mirrors 11L and 11R are in an opened state as illustrated in FIG. 2. A width (a length in the left-right direction) of the vehicle 10 including the side mirrors 11L and 11R at this time is referred to as a width D1.

When the side mirrors 11L and 11R, are not in use (for example, when the vehicle 10 is stopped), the side mirrors 11L and 11R are in a closed state as illustrated in FIG. 3. A width (the length in the left-right direction) of the vehicle 10 including the side mirrors 11L and 11R at this time is referred to as a width D2.

As illustrated in FIGS. 2 and 3, the width D2 of the vehicle 10 with the side mirrors 11L and 11R in the closed state is narrower than the width D1 of the vehicle 10 with the side mirrors 11L and 11R in the opened state, Therefore, for example, when the vehicle 10 enters a narrow parking space, the driver often performs an operation of setting the side mirrors 11L and 11R to the closed state so that the vehicle 10 does not collide with an obstacle in the surroundings of the vehicle 10.

The vehicle 10 further includes a front camera 12Fr, a rear camera 12Rr, a left lateral-side camera 12L, and a right lateral-side camera 12R. The front camera 12Fr is a digital camera that is provided in a front portion of the vehicle 10 and images a front side of the vehicle 10. The rear camera 12Rr is a digital camera that is provided in a rear portion of the vehicle 10 and images a rear side of the vehicle 10. The left lateral-side camera 12L is a digital camera that is provided in the left side mirror 11L of the vehicle 10 and images a left lateral side of the vehicle 10. The right lateral-side camera 12R is a digital camera that is provided in the right side mirror 11R of the vehicle 10 and images a right lateral side of the vehicle 10. The front camera 12Fr, the rear camera 12Rr, the left lateral-side camera 12L, and the right lateral-side camera 12R are examples of an imaging device of the present disclosure.

<Internal Configuration of Vehicle 10>

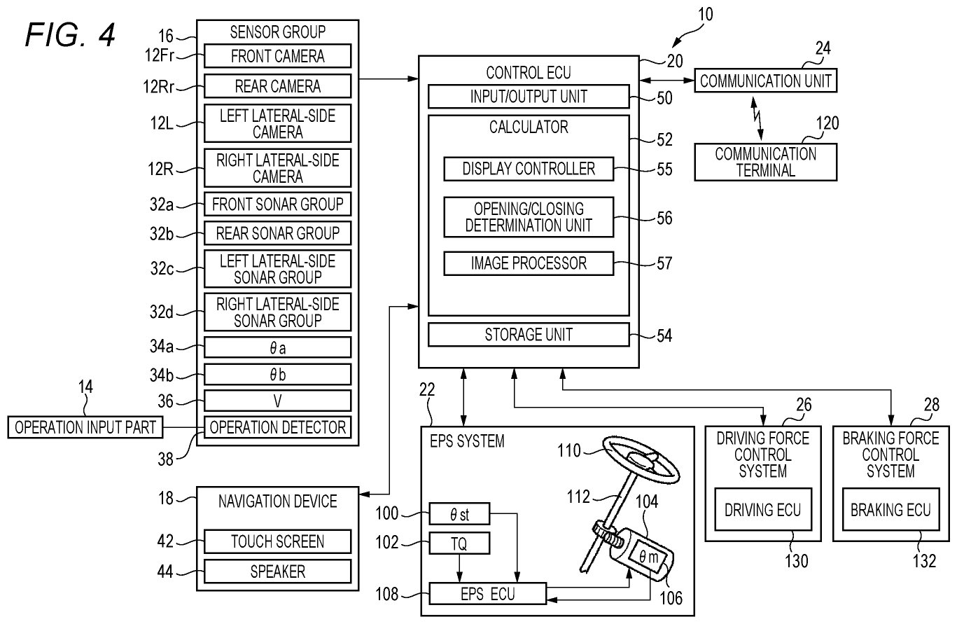

FIG. 4 is a block diagram illustrating an example of an internal configuration of the vehicle 10 illustrated in FIG. 1. As illustrated in FIG. 4, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28. The control ECU 20 is an example of a control device of the present disclosure.

The sensor group 16 obtains various types of detection values used for control performed by the control ECU 20. The sensor group 16 includes the front camera 12Fr, the rear camera 12Rr, the left lateral-side camera 12L, and the right lateral-side camera 12R. In addition, the sensor group 16 includes a front sonar group 32a, a rear sonar group 32b, a left lateral-side sonar group 32c, and a right lateral-side sonar group 32d. Further, the sensor group 16 includes wheel sensors 34a and 34b, a vehicle speed sensor 36, and an operation detector 38.

The front camera 12Fr, the rear camera 12Rr, the left lateral-side camera 12L, and the right lateral-side camera 12R output surroundings images obtained by imaging the surroundings of the vehicle 10. The surroundings images captured by the front camera 12Fr, the rear camera 12Rr, the left lateral-side camera 12L, and the right lateral-side camera 12R are referred to as a front image, a rear image, a left lateral-side image, and a right lateral-side image, respectively. The left lateral-side image and the right lateral-side image constitute a lateral-side image.

The front sonar group 32a, the rear sonar group 32b, the left lateral-side sonar group 32c, and the right lateral-side sonar group 32d emit sound waves to the surroundings of the vehicle 10 and receive reflected sounds from other objects. The front sonar group 32a includes, for example, four sonars. The sonars constituting the front sonar group 32a are provided at an obliquely left front side, a front left side, a front right side, and an obliquely right front side of the vehicle 10, respectively. The rear sonar group 32h includes, for example, four sonars. The sonars constituting the rear sonar group 32b are provided at an obliquely left rear side, a rear left side, a rear right side, and an obliquely right rear side of the vehicle 10, respectively. The left lateral-side sonar group 32c includes, for example, two sonars. The sonars constituting the left lateral-side sonar group 32c are provided at a front side and a rear side of a left side portion of the vehicle 10, respectively. The right lateral-side sonar group 32d includes, for example, two sonars. The sonars constituting the right lateral-side sonar group 32d are provided at a front side and a rear side of a right side portion of the vehicle 10, respectively.

The wheel sensors 34a and 34b detect a rotation angle of a wheel of the vehicle 10. The wheel sensors 34a and 34b may be implemented by an angle sensor or a displacement sensor. The wheel sensors 34a and 34b output a detection pulse each time the wheel rotates by a predetermined angle. The detection pulse output from the wheel sensors 34a and 34b is used to calculate the rotation angle of the wheel and a rotation speed of the wheel. A movement distance of the vehicle 10 is calculated based on the rotation angle of the wheel. The wheel sensor 34a detects, for example, a rotation angle θa of a left rear wheel. The wheel sensor 34b detects, for example, a rotation angle θb of a right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of the transmission.

The operation detector 38 detects content of an operation performed by a user using an operation input part 14, and outputs the detected content of the operation to the control ECU 20. The operation input part 14 includes, for example, a side-mirror switch that switches between an opened state and a closed state of the side mirrors 11L and 11R. In addition, the operation input part 14 may include various user interfaces such as a shift lever a select lever or a selector).

The navigation device 18 detects a current position of the vehicle 10 using, for example, a global positioning system (GPS), and guides the user to a route to a destination. The navigation device 18 includes a storage device (not illustrated) provided with a map information database.

The navigation device 18 includes a touch screen 42 and a speaker 44. The touch screen 42 functions as an input device and a display device of the control ECU 20. The user inputs various commands via the touch screen 42. The touch screen 42 displays various screens. Components other than the touch screen 42, for example, a smartphone may be used as the input device or the display device. The speaker 44 outputs various types of guidance information to an occupant of the vehicle 10 by voice.

The control ECU 20 includes an input/output unit 50, a calculator 52, and a storage unit 54. The calculator 52 is implemented by, for example, circuitry such as a central processing unit (CPU). The calculator 52 performs various types of control by controlling units based on a program stored in the storage unit 54.

The calculator 52 includes a display controller 55, an opening/closing determination unit 56, and an image processor 57.

The opening/closing determination unit 56 determines whether the side mirrors 11L and 11R are in the opened state or the closed state. The determination performed by the opening/closing determination unit 56 is performed, for example, based on a result of an operation of the side-mirror switch provided in the operation input part 14 that is detected by the operation detector 38. The determination by the opening/closing determination unit 56 may be performed based on a detection result of the state of the side mirrors 11L and 11R detected by sensors (not illustrated) provided in the side mirrors 11L and 11R.

The image processor 57 generates a surroundings image of the vehicle 10 based on imaging data obtained by the cameras of the vehicle 10. Specifically, the image processor 57 generates a bird's-eye view image showing a state of the surroundings of the vehicle 10 viewed from above, by synthesizing respective pieces of imaging data obtained by the front camera 12Fr, the rear camera 12Rr, the left lateral-side camera 12L, and the right lateral-side camera 12R.

In addition, the image processor 57 sets a mask area in the generated surroundings image (bird's-eye view image). The mask area refers to an area set to hide the body of the vehicle 10 reflected in a captured image. The image processor 57 may set mask areas in the lateral-side images (the left lateral-side image and the right lateral-side image) obtained by the left lateral-side camera 12L and the right lateral-side camera 12R.

A range in which the body of the vehicle 10 is reflected in the captured image differs depending on imaging data obtained by the camera. Therefore, the mask area set in the surroundings image also differs depending on a difference in the imaging data obtained by the camera. For example, the lateral-side images obtained by the left lateral-side camera 12L and the right lateral-side camera 12R differ depending on whether the side mirrors 11L and 11R to which the left lateral-side camera 12L and the right lateral-side camera 12R are attached are open or closed. Therefore, the range in which the body of the vehicle 10 is reflected, that is, the mask area set in the surroundings image differs depending on a difference in opening and closing of the side mirrors 11L and 11R. The image processor 57 sets mask areas having different sizes for the surroundings image of the vehicle 10 based on a determination result of the opened-closed state of the side mirrors 11L and 11R (namely, whether the side mirrors 11L and 11R are in a opened-state or a closed state) obtained by the opening/closing determination unit 56.

The display controller 55 causes the display device of the vehicle 10 to display the surroundings image generated by the image processor 57. Specifically, the display controller 55 causes the touch screen 42 to display a bird's-eye view image of the vehicle 10 generated by synthesizing respective pieces of imaging data of the front camera 12Fr, the rear camera 12Rr, the left lateral-side camera 12L, and the right lateral-side camera 12R. In addition, the display controller 55 causes the touch screen 42 to display the bird's-eye view image based on the determination result of the opening/closing determination unit 56. Specifically, the display controller 55 causes the touch screen 42 to display the bird's-eye view image including a mask area whose sizes are switched in accordance with the opening and closing of the side mirrors 11L and 11R.

The control ECU 20 may assist parking of the vehicle 10 by performing automatic steering. That is, an operation of a steering wheel 110 may be automatically performed under the control of the control ECU 20. Specifically, operations of an accelerator pedal (not illustrated), a brake pedal (not illustrated), and the operation input part 14 may be automatically performed.

The EPS system 22 includes a steering angle sensor 100, a torque sensor 102, an EPS motor 104, a resolver 106, and an EPS ECU 108. The steering angle sensor 100 detects a steering angle θst of the steering wheel 110. The torque sensor 102 detects a torque TQ applied to the steering wheel 110.

The EPS motor 104 applies a driving force or a reaction force to a steering column 112 coupled to the steering wheel 110, thereby enabling operation assistance of the steering wheel 110 and automatic steering at the time of parking assistance for the occupant. The resolver 106 detects a rotation angle θm of the EPS motor 104. The EPS ECU 108 controls the entire EPS system 22. The EPS ECU 108 includes an input/output unit (not illustrated), a calculator (not illustrated), and a storage unit (not illustrated).

The communication unit 24 enables wireless communication with another communication device 120. The other communication device 120 is a base station, a communication device of another vehicle, an information terminal such as a smartphone possessed by an occupant of the vehicle 10, or the like.

The driving force control system 26 is provided with a driving ECU 130. The driving force control system 26 executes driving force control of the vehicle 10. The driving ECU 130 controls an engine or the like (not illustrated) based on an operation that the user performs on the accelerator pedal (not illustrated), thereby controlling a driving force of the vehicle 10.

The braking force control system 28 is provided with a braking ECU 132, The braking force control system 28 executes braking force control of the vehicle 10. The braking ECU 132 controls a braking force of the vehicle 10 by controlling a brake mechanism or the like (not illustrated) based on an operation that the user performs on the brake pedal (not illustrated), thereby controlling a braking force of the vehicle 10.

<Display Control Performed by Control ECU 20>

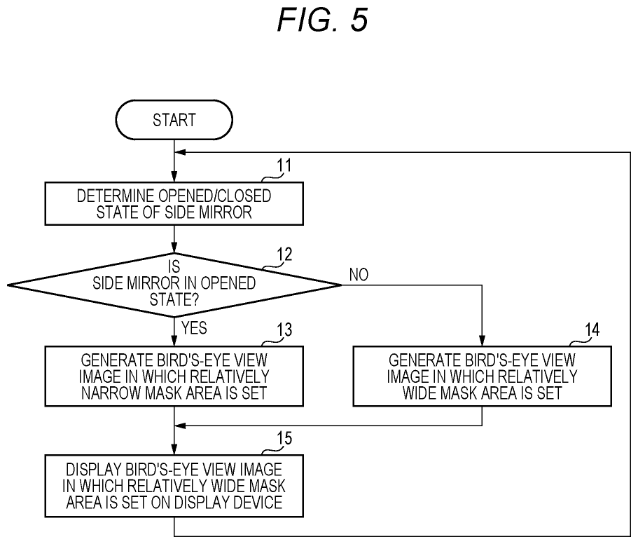

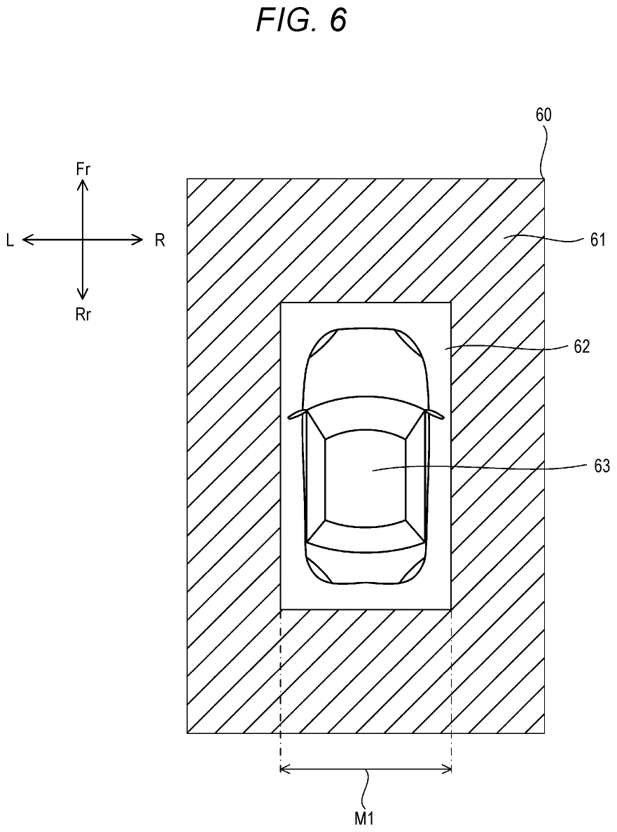

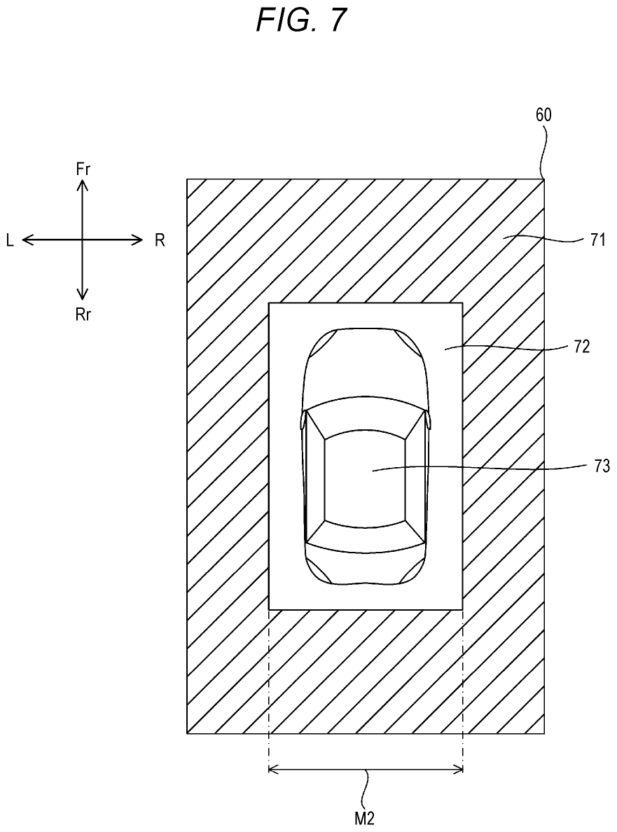

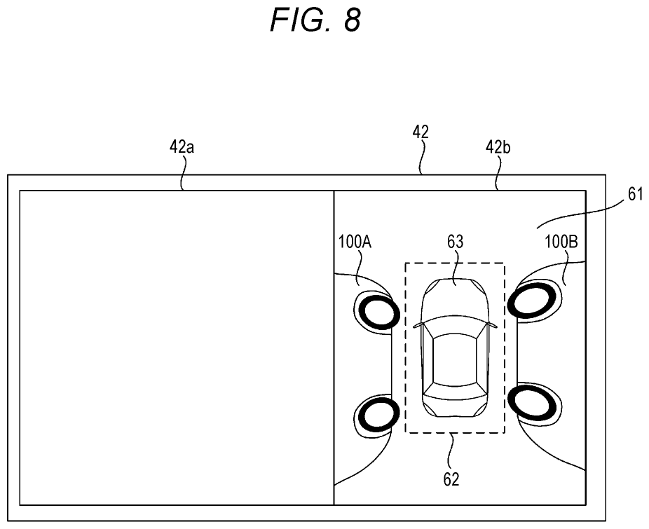

Next, display control performed by the control ECU 20 will be described with reference to FIGS. 5 to 8. FIG. 5 is a flowchart illustrating an example of the display control performed by the control ECU 20. FIG. 6 is a diagram illustrating an example of a mask area set when the side mirrors 11L and 11R are in the opened state. FIG. 7 is a diagram illustrating an example of a mask area set when the side mirrors 11L and 11R are in the closed state. FIG. 8 is a diagram illustrating an example of a bird's-eye view image displayed on the touch screen 42.

For example, when an ignition switch is turned on, the control ECU 20 starts the processing illustrated in FIG. 5.

First, the control ECU 20 causes the opening/closing determination unit 56 to determine the opened-closed state of the side mirrors 11L and 11R (step S11). The control ECU 20 determines whether the side mirrors 11L and 11R are in the opened state based on a determination result obtained by the opening/closing determination unit 56 in step S11 (step S12).

When it is determined in step S12 that the side mirrors 11L and 11R are in the opened state (step S12: Yes), the control ECU 20 causes the image processor 57 to generate a bird's-view image in which a relatively narrow mask area is set (step S13). The relatively narrow mask area is a mask area that is narrower than a mask area generated when the side mirrors 11L and 11R are in the closed state.

A bird's-eye view image 61 illustrated in FIG. 6 is an image that is generated by synthesizing respective pieces of imaging data of a front image, a rear image, a left lateral-side image, and a right lateral-side image obtained by the front camera 12Fr, the rear camera 12Rr, and the left lateral-side camera 12L and the right lateral-side camera 12R in the opened state, and that shows a state of the surroundings of the vehicle 10 viewed from above. The bird's-eye view image 61 is generated as, for example, an image configured in a rectangular shape. A mask area 62 is generated in a central portion of the bird's-eye view image 61. The mask area 62 is generated as, for example, an area having a rectangular shape similarly to the bird's-eye view image 61, In the mask area 62, a vehicle image 63 indicating the vehicle 10 is displayed in a superimposed manner on a portion (for example, a central portion) corresponding to a space in which the vehicle 10 is located. The vehicle image 63 is an image showing a state of the vehicle 10 viewed from above, and is an image generated (captured) in advance and stored in the storage unit 54 or the like. By displaying the vehicle image 63, the driver can easily grasp a positional relationship between the surroundings of the vehicle 10 and the vehicle 10.

For example, assuming that a width of the mask area 62 (a width in the left-right direction) is a width M1, the width M1 of the mask area 62 generated when the side mirrors 11L and 11R are in the opened state is set to be smaller than a width of the mask area (described later in FIG. 7) generated when the side mirrors 11L and 11R are in the closed state.

On the other hand, when it is determined in step S12 that the side mirrors 11L and 11R are not in the opened state (step S12: No), the control ECU 20 causes the image processor 57 to generate a bird's-eye view image in which a relatively wide mask area is set (step S14). The relatively wide mask area refers to a mask area relatively wider than the mask area set when the side mirrors 11L and 11R are in the opened state, that is, wider than the mask area 62 illustrated in FIG. 6 described above. The control ECU 20 generates a bird's-eye view image in which a mask area wider than the mask area 62 is set.

A bird's-eye view image 71 illustrated in FIG. 7 is an image that is generated by synthesizing respective pieces of imaging data of a front image, a rear image, a left lateral-side image, and a right lateral-side image obtained by the front camera 12Fr, the rear camera 12Rr, and the left lateral-side camera 12L and the right lateral-side camera 12R in a stored state (to be specific, the side mirrors 11L and 11R being in the closed state), and that shows a state of the surroundings of the vehicle 10 viewed from above. A mask area 72 is generated in a central portion of the bird's-eye view image 71. A vehicle image 73 is displayed in a superimposed manner in the mask area 72.

For example, assuming that a width of the mask area 72 is M2, the width M2 of the mask area 72 generated when the side mirrors 11L and 11R are in the closed state is set to be larger than the width M1 of the mask area 62 generated when the side mirrors 11L and 11R are in the opened state.

As described above, the bird's-eye view image 71 is an image generated by synthesizing the imaging data obtained by the front camera 12Fr, the rear camera 12Rr, and the left lateral-side camera 12L and the right lateral-side camera 12R in the stored state (to be specific, the side mirrors 11L and 11R being in the closed state). For example, the control ECU 20 performs conversion processing on respective pieces of imaging data obtained by the left lateral-side camera 12L and the right lateral-side camera 12R in the stored state, and generates the bird's-eye view image 71 by synthesizing the respective pieces of imaging data of the left lateral-side camera 12L and the right lateral-side camera 12R subjected to the conversion processing and the respective pieces of imaging data of the front camera 12Fr and the rear camera 12Rr.

The conversion processing performed on the imaging data is processing of cancelling a change in imaging conditions of the left lateral-side camera 12L and the right lateral-side camera 12R due to displacement of the side mirrors 11L and 11R. For example, when the side mirror 11L is displaced from the opened state to the closed state, the left lateral-side camera 12L provided in the side mirror 11L is also displaced, and thus imaging conditions such as an imaging position and an imaging direction of the left lateral-side camera 12L are changed. Therefore, the control ECU 20 performs conversion processing on the imaging data obtained from the left lateral-side camera 12L when the side mirror 11L is in the closed state so as to approach the imaging data obtained from the left lateral-side camera 12L when the side mirror 11L is in the opened state.

As an example, it is assumed that, when the side mirror 11L is changed from the opened state to the closed state, the imaging direction of the left lateral-side camera 12L is directed toward the rear side and is changed in a direction of approaching the body of the vehicle 10. In this case, the imaging data obtained by the left lateral-side camera 12L is imaging data including an image of the rear side of the vehicle 10 and imaging data including an image of the body of the vehicle 10. The control ECU 20 performs, as the conversion processing, processing of great enlargement toward the front side, on the imaging data obtained from the left later-side camera 12L when the side mirror 11L is in the closed state. Further, the conversion processing includes processing of correcting distortion or the like caused due to the processing of greatly enlarging the imaging data toward the front side. Accordingly, the imaging data obtained from the left lateral-side camera 12L when the side mirror 11L is in the closed state can be brought close to the imaging data obtained when the side mirror 11L is in the opened state, but includes the image of the body of the vehicle 10. Therefore, when the side mirror 11L is in the closed state, it is necessary to secure a wide mask area in order to hide the image of the body of the vehicle 10. Although the conversion processing on the imaging data obtained from the left lateral-side camera 12L has been described, the same applies to the conversion processing on the imaging data obtained from the right lateral-side camera 12R.

Next, when the bird's-eye view image 61 in which the relatively narrow mask area 62 is set is generated in step S13, the control ECU 20 proceeds to step S15, and causes the display controller 55 to display the generated bird's-eye view image 61 on the touch screen 42 that is the display device of the vehicle 10. Similarly, when the bird's-eye view image 71 in which the relatively wide mask area 72 is set is generated in step S14, the control ECU 20 proceeds to step S15, and causes the display controller 55 to display the generated bird's-eye view image 71 on the touch screen 42 of the vehicle 10.

As illustrated in FIG. 8, the touch screen 42 includes, for example, a first display area. 42a and a second display area 42b. The control ECU 20 displays the bird's-eye view image 61 generated in step S13 or the bird's-eye view image 71 generated in step S14 in the second display area 42b. In the example illustrated in FIG. 8, the bird's-eye view image 61 in which the relatively narrow mask area 62 generated when the side mirrors 11L and 11R are in the opened state is set is displayed. In the bird's-eye view image 61, a state in which an adjacent vehicle 100A and an adjacent vehicle 100B are parked on both left and right sides of the vehicle 10 indicated as the vehicle image 63 is displayed. Accordingly, the driver can check the surroundings of the vehicle 10 based on the bird's-eye view image 61 having a good and sufficient visible range in which, for example, the reflection of the body of the vehicle 10 is masked by the relatively narrow mask area 62.

Although not illustrated in FIG. 8, any image such as a front image based on imaging data obtained by the front camera 12Fr, a rear image based on imaging data obtained by the rear camera 12Rr, or a button image for the occupant of the vehicle 10 to give various instructions may be displayed in the first display area 42a.

In addition, when the bird's-eye view image 71 generated when the side mirrors 11L and 11R are in the closed state is displayed in the second display area 42b, the reflection of the body of the vehicle 10 that is included due to, for example, the conversion processing of greatly enlarging the imaging data can be masked by the relatively wide mask area 72. Accordingly, even when the side mirrors 11L and 11R are in the closed state, the driver can check the surroundings of the vehicle 10 based on the good bird's-eye view image 71.

As described above, the control ECU 20 controls the image processor 57 to se the mask areas 62 and 72 of predetermined ranges in the bird's-eye view images 61 and 71 based on a determination result of the opening/closing determination unit 56 that determines an opened-closed state of the side mirrors 11L and 11R. Accordingly, since the mask areas 62 and 72 of the bird's-eye view images 61 and 71 are set based on the opened-closed state of the side mirrors 11L and 11R, even when the imaging ranges of the left lateral-side camera 12L and the right lateral-side camera 12R are changed according to the opening/closing of the side mirrors 11L and 11R, it is possible to display the good bird's-eye view images 61 and 71 in a wide range without the body of the vehicle being reflected. Therefore, for example, it is possible to accurately check whether the vehicle 10 collides with an obstacle in the surroundings of the vehicle 10 while the vehicle 10 is entering a narrow parking space or leaving a narrow parking space. In addition, while the vehicle 10 is entering the narrow parking space, it is easy to check whether there is a space for allowing the occupant of the vehicle 10 to easily get off the vehicle 10 after the vehicle 10 is stopped. In addition, while the vehicle 10 is stopping, it is easy to check whether there is an obstacle that the occupant of the vehicle 10 comes into contact with at the time of getting off the vehicle 10.

When the side mirrors 11L and 11R are in the closed state, the control ECU 20 causes the image processor 57 to set the mask area 72 that is wider than the mask area 62 set when the side mirrors 11L and 11R are in the opened state. Accordingly, it is possible to mask the reflection of the vehicle 10 in the bird's-eye view image 71 by setting the relatively wide mask area 72 in a state where the side mirrors 11L and 11R are closed, and it is possible to secure a wide visible range in the bird's-eye view image 61 by setting the relatively narrow mask area 62 in a state where the side mirrors 11L and 11R are opened.

Although the embodiment of the present disclosure has been described above, the present disclosure is not limited to the above-described embodiment, and modifications, improvements, and the like can be made as appropriate.

For example, although the case in which the control ECU 20 displays the bird's-eye view images 61 and 71 on the touch screen 42 of the vehicle 10 is described in the above-described embodiment, the present disclosure is not limited thereto. For example, the control ECU 20 may display the bird's-eye view images 61 and 71 on a display screen of an information terminal (for example, a smartphone) possessed by an occupant of the vehicle 10 via the communication unit 24.

Although the case in which the mask areas 62 and 72 are formed in a rectangular shape is described in the above-described embodiment, the present disclosure is not limited thereto. For example, the mask areas 62 and 72 may be formed in an elliptical shape or a circular shape. In addition, a size of an area (front area) located in a traveling direction of the vehicle 10 (moving body) among the mask areas 62 and 72 may be changed from a size illustrated in FIG. 6, FIG. 7, and the like. The sizes and shapes of the mask areas 62 and 72 may be set for each individual vehicle 10 (moving body) or may be set by a user input. The sizes and shapes of the mask areas 62 and 72 may be set based on a time zone, a surrounding environment (for example, brightness of illuminance or the like, weather, presence or absence of a surrounding moving body, and a state of the surrounding moving body in case of presence) of the vehicle 10 (moving body), and the like.

Although an example in which the moving body is a vehicle is described in the above-described embodiment, the present disclosure is not limited thereto. The concept of the present disclosure can be applied not only to a vehicle but also to a robot, a boat, an aircraft, and the like that are provided with a driving source and movable by power of the driving source.

The control method described in the above embodiment can be implemented by executing a control program prepared in advance on a computer. The control program is recorded in a non-transitory computer-readable storage medium and is executed by being read from the storage medium. The control program may be provided in a form stored in a non-transitory storage medium such as a flash memory, or may be provided via a network such as the Internet. The computer that executes the control program may be provided in a control device, may be provided in an electronic device such as a smartphone, a tablet terminal, or a personal computer capable of communicating with the control device, or may be provided in a server device capable of communicating with the control device and the electronic device.

At least the following matters are described in the present specification. Although the corresponding components or the like in the above-described embodiment are shown in parentheses, the present disclosure is not limited thereto.

(1) A control device, including:

an image processor (image processor 57) that generates a surroundings image (bird's-eye view images 61 and 71) of a moving body (vehicle 10) based on imaging data obtained by an imaging device (left lateral-side camera 12L and right lateral-side camera 12R) provided in an operable and closable side mirror (side mirrors 11L and 11R) of the moving body;

a display controller (display controller 55) that causes a display device (touch screen 42) to display the surroundings image generated by the image processor; and

an opening/closing determination unit (opening/closing determination unit 56) that determines whether the side mirror is in an opened state or a closed state,

in which the image processor sets, in the surroundings image, a mask area (mask areas 62 and 72) of a range that is based on a determination result as to a state of the side mirror.

According to (1), since the mask area of the surroundings image is set based on whether the side mirror is in the opened state or the closed state, even if an imaging range of the imaging device is changed according to opening or closing of the side mirror, it is possible to display a good surroundings image.

(2) The control device according to (1),

in which the image processor sets the mask area wider then the side mirror is in a closed state than when the side mirror is in an opened state.

According to (2), in a state where the side mirror is closed, it is possible to widen the mask area to prevent the reflection of the moving body in the surroundings image, and in a state where the side mirror is opened, it is possible to narrow the mask area to enlarge a visible range in the surroundings image.

(3) The control device according to (1) or (2),

in which the imaging device includes a plurality of imaging devices, and

in which the surroundings image is a bird's-eye view image that is generated by synthesizing respective pieces of imaging data obtained by the plurality of imaging devices and that shows a state of surroundings of the moving body viewed from above.

According to (3), a driver can intuitively grasp the state of the surroundings of the vehicle.

(4) The control device according to any one of (1) to (3),

in which the surroundings image includes an image of the moving body (vehicle images 63 and 73).

According to (4), the driver can easily grasp a positional relationship between the surroundings of the vehicle and the vehicle.

(5) A control method to be executed by a control device including a processor configured to generate a surroundings image of a moving body based on imaging data obtained by an imaging device provided in a side mirror of the moving body and cause a display device to display the generated surroundings image, the control method including:

the processor determining whether the side mirror is in an opened state or a closed state; and

the processor setting, in the surroundings image, a mask area of a range that is based on a determination result as to a state of the side mirror.

According to (5), since the mask area of the surroundings image is set based on the side mirror is in an opened state or a closed state, even if an imaging range of the imaging device is changed according to opening or closing of the side mirror, it is possible to display a good surroundings image.

(6) A control program for causing a processor of a control device, which generates a surroundings image of a moving body based on imaging data obtained by an imaging device provided in a side mirror of the moving body and causes a display device to display the generated surroundings image, to execute the processing of:

determining whether the side mirror is in an opened state or a closed state; and

setting, in the surroundings image, a mask area of a range that is based on a determination result as to a state of the side mirror.

According to (6), since the mask area of the surroundings image is set based on whether the side mirror is in an opened state of an closed state, even if an imaging range of the imaging device is changed according to opening or closing of the side mirror, it is possible to display a good surroundings image.

1. A control device, comprising
circuitry configured to:
generate a surroundings image of a moving body based on imaging data obtained by an imaging device provided in an operable and closable side mirror of the moving body;
cause a display device to display the generated surroundings image; and
determine whether the side mirror is in an opened state or a closed state,
wherein the circuitry is configured to se, in the surroundings image, a mask area of a range that is based on a determination result as to a state of the side mirror.

2. The control device according to claim 1,
wherein the circuitry is configured to set the mask area wider when the side mirror is in the closed state than the mask area when the side mirror is in the opened state.

3. The control device according to claim 1,
wherein the imaging device includes a plurality of imaging devices, and
wherein the surroundings image is a bird's-eye view image that is generated by synthesizing respective pieces of imaging data obtained by the plurality of imaging devices and that shows a state of surroundings of the moving body viewed from above.

4. The control device according to claim 1,
wherein the surroundings image includes an image of the moving body.

5. A control method to be executed by a control device including a processor, wherein
the processor is configured to generate a surroundings image of a moving body based on imaging data obtained by an imaging device provided in a side mirror of the moving body and cause a display device to display the generated surroundings image, and
the control method comprises:
the processor determining whether the side mirror is in an opened state or a closed state; and
the processor setting, in the surroundings image, a mask area of a range that is based on a determination result as to a state of the side mirror.

6. A non-transitory computer-readable storage medium storing a control program for causing a processor of a control device to execute processing, wherein
the processor generates a surroundings image of a moving body based on imaging data obtained by an imaging device provided in a side mirror of the moving body and causes a display device to display the generated surroundings image, and
the processing comprises:
determining whether the side mirror is in an opened state or a closed state; and
setting, in the surroundings image, a mask area of a range that is based on a determination result as to a state of the side mirror.
